(19) United States
(12) Patent Application Publication
(10) Pub. No.: US 2015/0214767 A1
(43) Pub. Date: Jul. 30, 2015

(54) Safety Concept for Batteries

(71) Applicants: Robert Bosch GmbH, Stuttgart (DE); Samsung SDI Co., Ltd., Yongin-si, Gyeonggi-do (KR)

(72) Inventor: Holger Fink, Stuttgart (DE)

(21) Appl. No.: 14/408,007

(22) PCT Filed: Apr. 22, 2013
(86) PCT No.: PCT/EP2013/058263

§ 371 Date: Dec. 15, 2014

(30) Foreign Application Priority Data
Jun. 22, 2012 (DE) 10 2012 210 596.4

(51) Int. Cl. H02J 7/00

(52) U.S. Cl. CPC H02J 7/0063

(57) ABSTRACT

A safety device for batteries having battery cells that are configured to connect to poles of the battery via charging and isolating devices includes an apparatus. The apparatus is configured to discharge the battery cells. The apparatus is further configured to connect parallel to the battery cells. The apparatus can be a component of an inverter. The inverter includes electronic valves configured to switch on and off. The inverter is connected to poles of the battery. The electronic valve has at least one semiconductor switch of one electromechanical switch.

The present invention relates to a safety concept having a corresponding device and an associated method for batteries, in particular for traction batteries in hybrid vehicles or electric vehicles.

### PRIOR ART

Batteries which are provided for use in hybrid vehicles or electric vehicles are referred to as traction batteries since they are used for feeding electrical drives. In order to obtain the power data and energy data which are required in hybrid vehicles or electric vehicles, individual battery cells are connected in series and partially additionally in parallel. In the case of electric vehicles, for example 100 cells or more are connected in series, with the result that the total voltage of the battery can be up to 340 V. Batteries which are used in hybrid vehicles also usually exceed the voltage limit of 60 V which is categorized as unproblematic in the case of touching by humans.

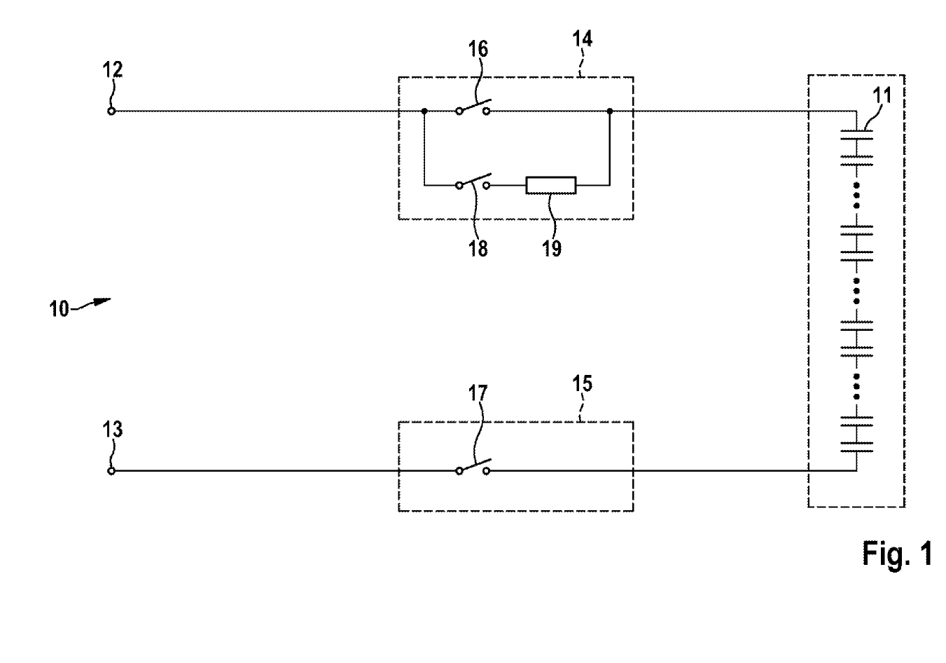

FIG. 1 illustrates the basic circuit diagram of a battery system according to the prior art. Such a battery system is described, for example, in DE-A 10 2010 027 850 with a detailed block circuit diagram.

In particular, FIG. 1 shows a battery 10 with assigned integrated electronics. A multiplicity of battery cells 11 are connected in series in order to obtain a high output voltage which is desired for a respective application. Optionally, the battery cells can also be connected in parallel in order to obtain a high battery capacity.

A charging and isolating device 14 is connected between the positive pole of the series circuit of the battery cells 11 and a positive battery terminal 12. In addition, an isolating device 15 is located between the negative pole of the series circuit of the battery cells 11 and a negative battery terminal 13. The charging and isolating device 14 and the isolating device 15 each comprises a contactor 16 and 17 as isolator switches. These contactors are provided for disconnecting the battery cells 11 from the battery terminals 12, 13, in order thereby to connect the battery terminals 12, 13 in a voltage-free fashion when required. Other switching means which are suitable for this application can also be used instead of contactors.

In addition, a charging contactor 18 is present in the charging and isolating device 14. A charging resistor 19 is connected in series with the charging contactor 18. The charging resistor 19 limits a charging current for the buffer capacitor which is connected into the DC voltage intermediate circuit of a customary battery-fed drive system when the battery is connected to the DC voltage intermediate circuit. When predefinable events occur, the battery can be activated or deactivated at one pole or two poles with the arrangement of the charging and isolating device (illustrated in FIG. 1) in the positive line and the isolating device in the negative line. For this purpose a control device which is not illustrated provides corresponding signals which activate the contactors.

By using the charging resistor 19, balancing currents can also be limited during the activation of the battery. In the case of an activation process, the charge switch 18 is firstly closed here in the charging and isolating device 14, with the isolator switch 16 opened, and additionally, if desired, the isolator switch 17 in the isolating device at the negative pole of the battery system is closed. The input capacities of externally connected systems are then charged by means of the charging resistor 19. If the voltage between the positive pole and the negative pole of the battery system differs only insignificantly from the total voltage of the battery cells, the charging process is terminated by closing the isolator switch in the charging and isolating device 14. The battery system is then connected with low impedance to the external systems and can be operated with its specified power data. Overall, the balancing currents which occur between the external systems and the battery system when the battery system is activated, can be limited to permissible values.

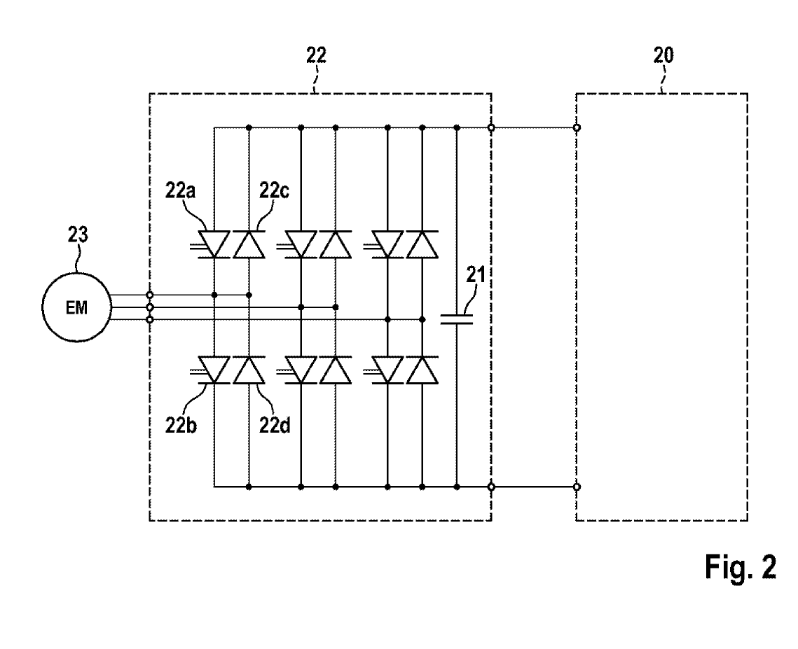

FIG. 2 illustrates an electric drive system, known, for example, from DE-A 10 2010 027 864.5, for an electric vehicle or hybrid vehicle as a basic circuit diagram. Here, a battery 20 is connected to a DC voltage intermediate circuit which is buffered by a capacitor 21. A pulse-controlled inverter 22, which makes available sinusoidal voltages, which are phase-offset with respect to one another at three outputs via, in each case, two switchable semiconductor valves 22a, 22b and two diodes 22c and 22d, for operating an electric drive motor 23, for example a three phase machine, is connected to the DC voltage intermediate circuit. The capacity of the capacitor 21 has to be large enough to stabilize the voltage in the DC voltage intermediate circuit for a period of time in which one of the switchable semiconductor valves is activated.

The electric drive system which is known from DE-A 10 2010 027 864.5 comprises a battery 20 which has, similarly to the battery 10 illustrated in FIG. 1, a multiplicity of battery cells which are connected in series. A charging and isolating device is present in the positive line and an isolating device is present in the negative line, between this series circuit comprising battery cells and the positive and negative terminals of the battery 20. By means of these isolating devices it is possible, as in the case of the battery 10 from FIG. 1, to disconnect the positive pole of the battery and/or the negative pole of the battery from the battery cells in the case of an accident or in the event of a malfunction when a connectable of the charger device is not operating satisfactorily, and thereby switch to a voltageless state. In particular, two-pole disconnection of the battery from the traction on-board power system is proposed in order to place the battery in a safe state. The electric charge which is stored in the battery cells is still retained in this case.

### DISCLOSURE OF THE INVENTION

A possible reaction can originate from the still-charged battery cells even after they are disconnected, if a short-circuit is triggered by certain effects. This can still occur even after a relatively long time. The advantage of the invention is that in a safety concept for batteries, in particular for traction batteries, the battery or the individual battery cells is/are placed in a non-critical state in which external effects or influences cannot lead to dangerous situations.

This advantage is achieved by placing the battery cells in a safe state after their disconnection from external connections, in particular after the disconnection from the traction on-board power system of a vehicle by discharging.

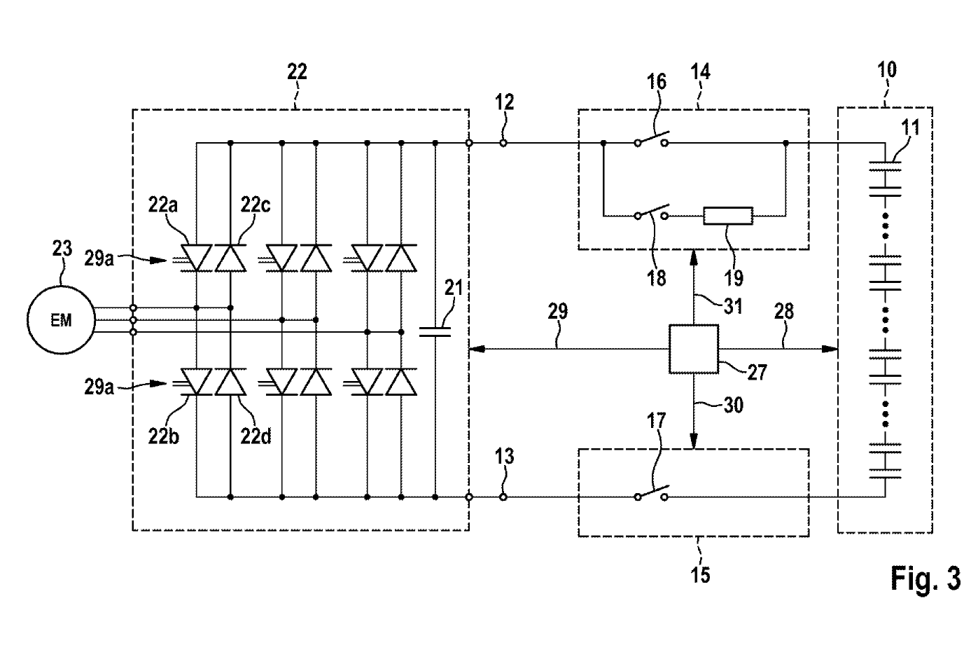

So that the advantages of the invention are achieved, discharging means, specified in FIG. 3, are added to a system, in particular a battery according to the prior art. These additional discharging means are actuated in a particularly advantageous way using the battery management system which outputs corresponding actuation signals.

It is particularly advantageous that the inventive discharging of the battery cells is initiated immediately after a two-pole disconnection of the battery cells. For this purpose, the discharging means are advantageously actuated with their switches or contactors using the battery management system in such a way that the discharging of the battery cells takes place. The battery management system outputs the actuation signals for the switches as soon as it detects that the battery has been disconnected.

A further advantage is provided by the possibility of carrying out additional discharging of the battery and of the battery cells by means of additional electronics for equalizing the state of charge of the battery cells. In such an arrangement, which carries out what is referred to as cell balancing, the ohmic resistors then present can advantageously be used to discharge the cells, or can additionally also be included in the discharging.

FIG. 3 illustrates an exemplary embodiment of the invention. The components as specified in FIG. 3 correspond to the components described in more detail in FIGS. 1 and 2 and have the same reference symbols.

In addition, in the exemplary embodiment of the invention according to FIG. 3, means for discharging the battery cells can be connected parallel to the series circuit of the battery cells 11. For this purpose, according to the exemplary embodiment in FIG. 3, the inverter is used, the actuable elements of which are suitably actuated by the battery management system 27. In this context, the battery management system 27 immediately initiates discharging of the battery cells 11 after the disconnection, in particular two-pole disconnection of the battery.

In the exemplary embodiment according to FIG. 3, a battery management system 27 is also present in addition to the components according to FIG. 1 or FIG. 2. The battery management system 27 is connected via suitable connections 28, 29, 30, 31 to the battery or 20, the charging and isolating device 14, the isolator switch 17 and the inverter 22, which operates, for example, as a pulse-controlled inverter. These connections are illustrated only symbolically, but they permit, for example, the transmission of actuation signals etc. In the case of the inverter 22, the connection of the battery management system 27, illustrated as the arrow 29a, leads to the switchable semiconductor valves 22a and 22b.

In a further refinement of the invention, additional discharging of the battery and/or of the battery cells can occur via electronics, then present or necessary, for equalizing the state of charge of the battery cells 11. In such an arrangement, which can comprise balancing resistors and actuable valves and which preferably carries out what is referred to as cell balancing by means of the battery management system 27, the ohmic resistors, which are present, in the balancing circuit can be used to discharge the cells or can additionally also be included in the discharging.

The actuation of the electronic valves, which can be switched on and off, of the pulse-controlled inverter or of the additional electronics by the battery management system 27 is carried out after the single-pole or two-pole decoupling of the battery cells 11 if the battery management system 27 detects such a request on the basis of certain predefinable criteria.

Advantageous procedures for discharging the battery cells will now be presented.

The battery management system 27 firstly carries out insulation resistance checking after the two-pole disconnection with the isolator switches 16, 17 opened. In this context it is checked whether the high voltage circuit of the battery 10, 20 still has sufficient electrical insulation resistance to the vehicle mass. If the insulation resistance does not undershoot a defined limiting value, the electronics of the inverter are informed, via the communication interface of the traction drive, for example what is referred to as a “drive CAN”, by the battery management system 27, that the battery 10, 20 wishes to set the “place battery in safe state” operating mode. The communication interface of the traction drive, for example what is referred to as a “drive CAN”, corresponds, for example, to the connection 29 between the battery management system and the inverter 22 in FIG. 3.

Subsequently, under certain circumstances the inverter electronics (not illustrated in the figure) also carry out insulation resistance checking. If this testing is successful, the following procedure is adopted:

a). The inverter 22 firstly switches both power switches on in at least one of its three branches. Here, it is appropriate, but not absolutely necessary, to switch on all 6 power switches of the 3 branches.

b). The inverter informs the battery 10, 20 via the communication interface 29 of the traction drive that it is ready for the “place battery in safe state” mode.

c). Subsequently, the charge switch of the charging and isolating device 14 of the battery 10 is firstly closed. If the battery 10 has a second isolating device 15, the isolator switch 17 of this isolating device 15 is subsequently closed. The battery cells 11 are now short-circuited via the charging resistor 19 of the charging and isolating device 14. The battery cells 11 are therefore discharged. No torque is generated in the electric machine 23 owing to the selected actuation of the inverter 22.

In a battery system according to the prior art, the charging resistor 19 is used only to charge the DC voltage intermediate circuit capacitor 21. The charging resistor 19 therefore does not have to conduct relatively large currents continuously and is therefore also not configured for such operation, for reasons of cost and space.

If the charging resistor 19 is, in the way described according to the invention, part of the safety concept, the charging resistor 19 must either be configured for relatively high continuous power levels or the battery management system models the temperature of the charging resistor 19 in a model. As soon as a limiting temperature is exceeded, the battery management system 27 opens the charge switch of the charging and isolating device 14 and/or the isolator switch 17 in the second, optional isolating device 15.

After the temperature of the charging resistor 19 has decreased, the switches are, as described, closed again and the cells 11 are discharged again. In this way, the cells of the battery system are discharged to such an extent that even a possible internal or external short-circuit occurring later, for example due to strong heating or formation of sparks, can no longer pose a risk due to burning battery cells or fires which are caused by an external short-circuit.

After the “place battery in safe state” operating mode has ended, the battery 10 is appropriately disconnected again by opening the isolator switches 16, 17 in a two-pole fashion from the traction on-board power system, which is symbolized by the capacitor 21.

By applying the described safety concept, the safety of electrical traction drives or of traction batteries can be considerably improved compared to the prior art. The following technical measures are taken for this purpose:

The charging resistor of the charging and isolating device of the battery must, under certain circumstances, be configured for relatively high continuous currents.

The power switches 22a, 22c in the inverter 22 must both be capable of being switched on simultaneously in at least one of the branches. In known solutions this is prevented, for example, by means of hardware locks in the actuation circuits of the semiconductor switches. The actuation circuits must therefore, according to the invention, be expanded, under certain circumstances, with a “place battery in safe state” operating mode.

The “place battery in safe state” operating mode is additionally introduced functionally into the software of the battery management system and into the control software of the inverter electronics.

The described safety concept can be used advantageously not only in the case of accidents. It is basically appropriate also to place the battery cells 11 in a discharged state in the event of technical problems. An example of this is a charging process of a battery in an electric vehicle, in which, due to a fault, the charger device does not reduce the charging current even though the battery 10, 20 is fully charged. In this case, the new safety concept would provide that the charger device is switched off via an electromechanical switch which is protects the charging current circuit. This is not shown in FIG. 2 since it is specific to the electric vehicle and plug-in hybrid vehicles. Subsequently, the battery can be discharged in the way described. This ensures that the battery 10, 20 has been placed in a safe state.

1. A safety device for a battery, comprising:
an apparatus configured to discharge battery cells and connect parallel to the battery cells
wherein the battery includes the battery cells and the battery cells are configured to connect to poles of the battery via charging and isolating devices.

2. The safety device for batteries as claimed in claim 1, wherein the battery is a traction battery.

3. The safety device as claimed in claim 1, wherein the apparatus is a component of an inverter, the inverter includes electronic valves, the electronic valves are configured to switch on and off and the inverter is connected to the poles of the battery.

4. The safety device as claimed in claim 2, wherein the electronic valves have at least one semiconductor switch or one electromechanical switch.

5. The safety device as claimed in claim 1, wherein the apparatus is further configured to:
activate with a battery management system.

6. The safety device as claimed in claim 1, further comprising:
electronics configured to equalize state of charge of the battery cells, wherein the electronics include balancing resistors and actuable elements, the electronics are connected to a battery management system and configured to actuate using the battery management system, and the balancing resistors are configured to discharge the battery cells.

7. A method for discharging a battery, comprising:
detecting a disconnection, using a battery management system, of the battery cells from at least one battery pole of two battery poles, wherein the battery includes the two battery poles and the battery further includes battery cells, the battery cells are configured to connect to the poles of the battery via charging and isolating devices;
connecting an apparatus configured to discharge the battery cells parallel to the battery cells with the battery management system if the battery management system detects the disconnection of the battery cells from the at least one battery pole.

8. The method as claimed in claim 7, further comprising:
sending actuation signals, using the battery management system, to the apparatus to connect the apparatus parallel to the battery cells.

9. The method as claimed in claim 7, further comprising:
discharging the battery cells after the disconnection of the battery cells from the two battery poles.

10. The method as claimed in claim 9, further comprising:
checking resistance of an insulation before the discharging of the battery cells.

11. The method as claimed in claim 7, wherein the method is carried out until the battery is in a safe state.

12. The method as claimed in claim 7, wherein the method is used in a hybrid vehicle or electric vehicle.
